(19) United States
(12) Patent Application Publication
(10) Pub. No.: US 2026/0134701 A1
(43) Pub. Date: May 14, 2026

(54) METHOD AND APPARATUS WITH MULTIMODAL DATA PROCESSING

(71) Applicants: Samsung Electronics Co., Ltd., Suwon-si (KR); Korea Advanced Institute of Science and Technology, Daejeon (KR)

(72) Inventors: Hyeongseok SON, Suwon-si (KR); Muhammad Adi NUGROHO, Daejeon (KR); Inyong KOO, Daejeon (KR); Changick KIM, Daejeon (KR)

(73) Assignees: Samsung Electronics Co., Ltd., Suwon-si (KR); Korea Advanced Institute of Science and Technology, Daejeon (KR)

(21) Appl. No.: 19/274,934

(22) Filed: Jul. 21, 2025

(30) Foreign Application Priority Data
Nov. 14, 2024 (KR) 10-2024-0162386
Feb. 17, 2025 (KR) 10-2025-0020364

(51) Int. Cl. G06V 20/64; G06V 10/26; G06V 10/77

(52) U.S. Cl. CPC G06V 20/64; G06V 10/26; G06V 10/7715

(57) ABSTRACT

A processor-implemented method including masking a point cloud according to a mask, the mask being formed as a grid, training a first auto-encoder to reconstruct coordinates and densities of masking points of the point cloud, the masking points respectively corresponding to masking grid cells of the mask, from residual points of the point cloud, the residual points respectively corresponding to residual grid cells of the mask, and training a second auto-encoder to reconstruct colors, the coordinates, and the densities of the masking points from an image corresponding to the point cloud.

### CROSS-REFERENCE TO RELATED APPLICATIONS

This application claims the benefit under 35 USC § 119 (a) of Korean Patent Application No. 10-2024-0162386, filed on Nov. 14, 2024, and Korean Patent Application No. 10-2025-0020364, filed on Feb. 17, 2025, in the Korean Intellectual Property Office, the entire disclosures of which are incorporated herein by reference for all purposes.

### BACKGROUND

### 1. Field

The following description relates to a method and apparatus with multimodal data processing.

### 2. Description of Related Art

Recently, the development of deep learning has greatly accelerated the development of autonomous driving, resulting in the development of effective three-dimensional (3D) recognition models for various driving tasks. These 3D recognition models are used for tasks such as 3D object detection and bird's eye view (BEV) map segmentation and may rely on an image input and light detection and ranging (LiDAR). LiDAR may provide spatial information, and image data may provide semantic context, so 3D recognition models using LiDAR and image data are useful for understanding a surrounding environment, detecting an obstacle, and ensuring safe navigation. There is a recognized desire to develop technology for 3D recognition models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including masking a point cloud according to a mask, the mask being formed as a grid, training a first auto-encoder to reconstruct coordinates and densities of masking points of the point cloud, the masking points respectively corresponding to masking grid cells of the mask, from residual points of the point cloud, the residual points respectively corresponding to residual grid cells of the mask, and training a second auto-encoder to reconstruct colors, the coordinates, and the densities of the masking points from an image corresponding to the point cloud.

A first encoder of the trained first auto-encoder and a second encoder of the trained second auto-encoder may be respectively configured to output embedding data of an input point cloud and an input image.

The training of the first auto-encoder may include obtaining a point cloud feature by applying, to a first encoder of the first auto-encoder, the point cloud being voxelized responsive to the masking, obtaining a first bird's eye view (BEV) feature by converting the point cloud feature obtained from the first encoder into a BEV space, and training, from the first BEV feature, the first auto-encoder to reconstruct the coordinates and the densities of the masking points in a first decoder of the first auto-encoder.

The obtaining of the point cloud feature may include replacing masking voxels corresponding to the masking grid cells in the voxelized point cloud with point tokens and applying the point tokens to the first encoder.

The training of the second auto-encoder may include obtaining an image feature by applying the image to a second encoder of the second auto-encoder, obtaining a second bird's eye view (BEV) feature obtained by converting the image feature obtained from the second encoder into a BEV space, based on depth information of the image, and training, from the second BEV feature, the second auto-encoder to reconstruct the colors, the coordinates, and the densities of the masking points in a second decoder of the second auto-encoder.

The training of the first auto-encoder may include training the first auto-encoder based on a first loss function of the first auto-encoder, the first loss function of the first auto-encoder being defined to minimize a first distance between a predicted point in the first auto-encoder and a ground-truth (GT) point and the GT point may include, among the masking points of the point cloud, a masking point closest to the predicted point.

The training of the first auto-encoder may include training the first auto-encoder based on a third loss function, the third loss function being defined to minimize a first difference between a predicted density corresponding to a masking grid cell in the first auto-encoder and a ground-truth (GT) density is minimized and the GT density may be obtained by dividing a number of the masking points of the point cloud corresponding to the masking grid cells by a volume of voxels of the point cloud corresponding to the masking grid cells.

The training of the first auto-encoder may include training the first auto-encoder based on a fourth loss function, the fourth loss function being defined to minimize a second difference between a predicted surface normal corresponding to a masking grid cell in the first auto-encoder and a ground-truth (GT) surface normal and the GT surface normal may be obtained by performing eigendecomposition on a covariance matrix of a relative coordinate distribution of points in voxels, the covariance matrix being calculated based on a centroid of the voxels of the point cloud corresponding to the masking grid cells.

The training of the second auto-encoder may include training the second auto-encoder based on a first loss function of the second auto-encoder, the first loss function of the second auto-encoder being defined to minimize a second distance between a predicted point and a ground-truth (GT) point and the GT point may include, among points included in the point cloud, a point that is closest to the predicted point.

The training of the second auto-encoder may include obtaining a projection matrix corresponding to the point cloud and the image, determining a color value of a pixel in the image onto which a point of the point cloud is projected to be a color value of the point, based on the projection matrix, and training the second auto-encoder based on a second loss function of the second auto-encoder, the second loss function of the second auto-encoder being defined to minimize a third difference between a color value of a predicted point and a color value of a ground-truth (GT) point is minimized, and the GT point may include, among points included in the point cloud, a point that is closest to the predicted point.

The training of the second auto-encoder may include training the second auto-encoder based on a third loss function of the second auto-encoder, the third loss function of the second auto-encoder being defined to minimize a fourth difference between a predicted density corresponding to a grid cell of the point cloud in the second auto-encoder and a ground-truth (GT) density and the GT density may be obtained by dividing a number of the masking points of the point cloud corresponding to the masking grid cells by a volume of voxels of the point cloud corresponding to the masking grid cells.

The point cloud may include data sensed by light detection and ranging (LiDAR) and the image may include data captured by a camera that senses at least a portion of a scanning range of the LiDAR.

The method may include obtaining embedding data of an input point cloud and an input image based on a first encoder of the trained first auto-encoder and a second encoder of the trained second auto-encoder and obtaining an object detection result based on the embedding data.

The method may include obtaining embedding data of an input point cloud and an input image based on a first encoder of the trained first auto-encoder and a second encoder of the trained second auto-encoder and obtaining a map segmentation result based on the embedding data.

In a general aspect, here is provided a non-transitory computer-readable storage medium storing instructions that, when executed by a processor, cause the processor to mask a point cloud according to a mask, the mask being formed as a grid, train a first auto-encoder to reconstruct coordinates and densities of masking points of the point cloud, the masking points respectively corresponding to masking grid cells of the mask, from residual points of the point cloud, the residual points respectively corresponding to residual grid cells of the mask, and train a second auto-encoder to reconstruct colors, the coordinates, and the densities of the masking points from an image corresponding to the point cloud.

In a general aspect, here is provided an electronic device including at least one processor, a memory configured to store instructions, and the instructions, when executed by the at least one processor, cause the electronic device to perform masking a point cloud according to a mask, the mask being formed as a grid, training a first auto-encoder to reconstruct coordinates and densities of masking points of the point cloud, the masking points respectively corresponding to masking grid cells of the mask, from residual points of the point cloud, the residual points respectively corresponding to residual grid cells of the mask, and training a second auto-encoder to reconstruct colors, the coordinates, and the densities of the masking points from an image corresponding to the point cloud.

The training of the first auto-encoder may include obtaining a point cloud feature by applying, to a first encoder of the first auto-encoder, the point cloud being voxelized responsive to the masking, obtaining a first bird's eye view (BEV) feature by converting the point cloud feature obtained from the first encoder into a BEV space, and training, from the first BEV feature, the first auto-encoder to reconstruct the coordinates and the densities of the masking points in a first decoder of the first auto-encoder.

The obtaining of the point cloud feature may include replacing masking voxels corresponding to the masking grid cells in the voxelized point cloud with point tokens and applying the point tokens to the first encoder.

The training of the second auto-encoder may include obtaining an image feature by applying the image to a second encoder of the second auto-encoder, obtaining a second bird's eye view (BEV) feature obtained by converting the image feature obtained from the second encoder into a BEV space, based on depth information of the image, and training, from the second BEV feature, the second auto-encoder to reconstruct the colors, the coordinates, and the densities of the masking points in a second decoder of the second auto-encoder.

A first encoder of the trained first auto-encoder and a second encoder of the trained second auto-encoder are configured to output embedding data of an input point cloud and an input image.

Other features and aspects will be apparent from the following detailed description, the drawings, and the claims.

### BRIEF DESCRIPTION OF THE DRAWINGS

FIG. 1 illustrates an example system with multimodal data processing according to one or more embodiments.

FIG. 2 illustrates an example method with multimodal data processing according to one or more embodiments.

FIG. 3 illustrates example points corresponding to grid cells of a mask according to one or more embodiments.

FIG. 4 illustrates an example masking of a point cloud according to one or more embodiments.

FIG. 5 illustrates an example training pipeline of a bird's eye view masked multimodal auto-encoder (BEV-MMAE) according to one or more embodiments.

FIG. 6 illustrates an example reconstruction objective of a BEV-MMAE according to one or more embodiments.

FIG. 7 illustrates an example process of obtaining an object detection result and a map segmentation result according to one or more embodiments.

FIG. 8 illustrates an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

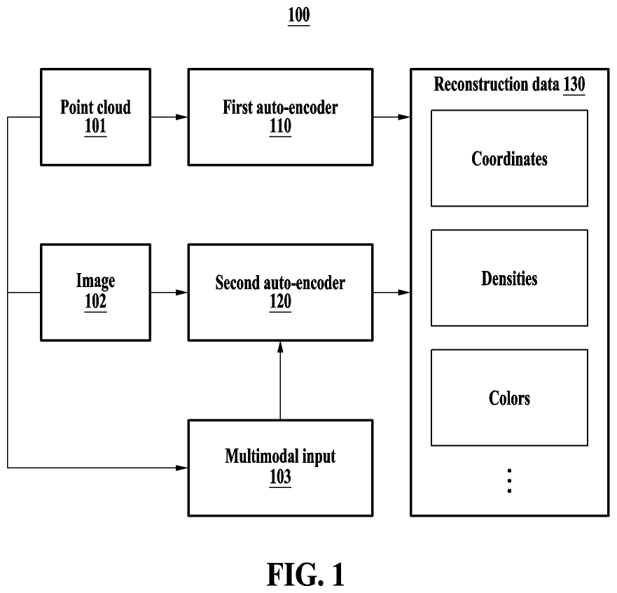

FIG. 1 illustrates an example system with multimodal data processing according to one or more embodiments.

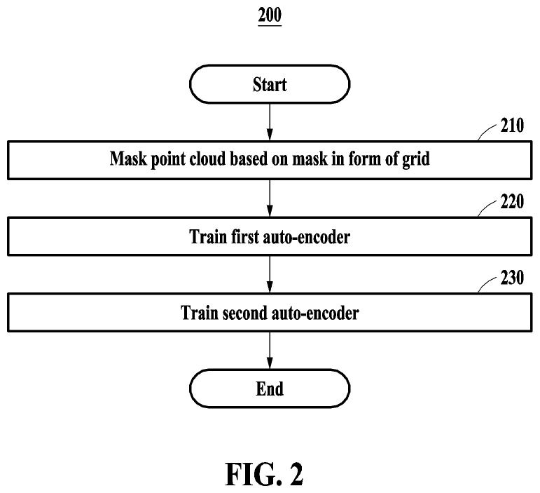

Referring to FIG. 1, in a non-limiting example, a system 100 for processing multimodal data may be a system for processing multimodal data including a point cloud 101 and an image 102. The system 100 may perform a multimodal data processing method (e.g., multimodal data processing method 200 of FIG. 2).

The multimodal data may include the point cloud 101 and the image 102. The point cloud 101 may include data sensed by light detection and ranging (LiDAR). For example, the point cloud 101 may include the point cloud 101 corresponding to a driving environment, which is sensed by LiDAR installed on a moving object (e.g., a car, etc.). The image 102 may include data sensed by an image sensor, such as a camera, etc. For example, the image 102 may include a red, green, and blue (RGB) image corresponding to a driving environment, which is captured by a camera installed on a moving object (e.g., a car, etc.). For example, the image 102 may include a plurality of images captured at different points of view (POV).

The image 102 may be an image corresponding to the point cloud 101. For example, the image 102 may include data captured by a camera that senses at least a portion of a scanning range of LiDAR that senses the point cloud 101. That is, at least a portion of a space corresponding to the point cloud 101 and at least a portion of a space corresponding to the image 102 may overlap each other. That is, at least a portion of a space detected by LiDAR and at least a portion of a space captured by a camera may overlap each other.

In an example, the system 100 may include a first auto-encoder 110 that receives the point cloud 101 as an input and a second auto-encoder 120 that receives the image 102 as an input. The system 100 may perform an operation of performing self-supervised learning on the first auto-encoder 110 and the second auto-encoder 120.

In an example, the first auto-encoder 110 and the second auto-encoder 120 may be trained to output reconstruction data 130. The reconstruction data 130 is data that reconstructs a portion or all of the point cloud 101 and may be trained to reconstruct, for example, coordinates of at least some points of the point cloud 101, densities of at least some areas of the point cloud 101, and colors of at least some points of the point cloud 101.

The first auto-encoder 110 may be trained to receive a partial area of the point cloud 101 as an input and reconstruct other partial areas. For example, the first auto-encoder 110 may be trained to receive a partial area of the point cloud 101 as an input and reconstruct the coordinates of points included in other partial areas and the densities of other partial areas.

The coordinates of the points may be information indicating the position of the points in the point cloud 101. The coordinates of the points may include, for example, a coordinate (e.g., xyz coordinate) in a three-dimensional (3D) space corresponding to the point cloud 101. For example, the first auto-encoder 110 may be trained to reconstruct coordinates of other points from at least a portion of the point cloud 101. For example, the second auto-encoder 120 may be trained to reconstruct the coordinates of at least some points of the point cloud 101 from the image 102 and a multimodal input 103.

The density is the density of a certain area of the point cloud 101 and may refer to a ratio of the number of points included in a certain area to the volume of the certain area. In an example, the density of a certain area of the point cloud 101 may be calculated by dividing the number of points included in the certain area by the volume of the certain area. For example, the first auto-encoder 110 may be trained to reconstruct the densities of other partial areas from at least a portion of the point cloud 101.

In an example, the first auto-encoder 110 may be trained to receive a partial area of the point cloud 101 as an input and reconstruct a surface normal of other partial areas. A partial area of the point cloud 101 that is input to the first auto-encoder 110 may be determined based on a mask. That is, the point cloud 101, having had masking performed upon it based on the mask, may be input to the first auto-encoder 110. Masking of the point cloud 101 is described in greater detail below.

In an example, the second auto-encoder 120 may be trained to receive the image 102 as an input and reconstruct at least partial areas of the point cloud 101. For example, the second auto-encoder 120 may be trained to receive the image 102 corresponding to the point cloud 101 as an input and reconstruct the coordinates of points included in the point cloud 101 and the density of each area in the point cloud 101.

In an example, the second auto-encoder 120 may be trained to receive at least one of the image 102 and the multimodal input 103 as an input and reconstruct the color of each point of the point cloud 101.

Thus, the system 100 may generate the multimodal input 103 from the point cloud 101 and the image 102. The multimodal input 103 may be data obtained by fusing pieces of data of different types (or modes) and may include, for example, the point cloud 101 including color information. The point cloud 101 including the color information may correspond to data of the point cloud 101 including the color information of each point included in the point cloud 101. The color information of each point included in the point cloud 101 may be obtained from the image 102. Each point included in the point cloud 101 may be mapped to a pixel in the image 102. The color information of a point may be determined to be a color value of a pixel in the image 102, which is mapped to the point.

The multimodal data processing method performed in the system 100 may include a self-supervised learning method of the first auto-encoder 110 and the second auto-encoder 120. The first auto-encoder 110 and the second auto-encoder 120 may be trained based on a predefined loss function. The self-supervised learning method of the first auto-encoder 110 and the second auto-encoder 120 is described in greater detail below.

FIG. 2 illustrates an example method with multimodal data processing according to one or more embodiments.

Referring to FIG. 2, in a non-limiting example, a multimodal data processing method 200 may include operation 210 of masking the point cloud based on a mask in the form of a grid.

In an example, the multimodal data processing method 200 may include a self-supervised learning method of a model capable of processing a multimodal data input. For example, the model may include an auto-encoder. As described above, the model capable of processing the multimodal data input may include a first auto-encoder for processing a point cloud and a second auto-encoder for processing an image.

The mask in the form of a grid may refer to an array of binary values (0 or 1) defined in a grid structure to select or filter a certain area in the point cloud. For example, the mask in the form of a grid may correspond to a two-dimensional (2D) array corresponding to a certain plane in a 3D space corresponding to the point cloud. For example, when the 3D space corresponding to the point cloud is a 3D space expressed as an x-axis, a y-axis, and a z-axis, the mask in the form of a grid may correspond to an array in the form of a grid corresponding to a bird's eye view (BEV) plane (or xy plane) obtained by compressing the 3D space with respect to the z-axis.

Each grid cell of the mask may indicate a certain area of the point cloud. The 3D space corresponding to the point cloud may be divided into a plurality of voxels, and each voxel may correspond to each grid cell of the mask.

For example, assuming that the size of the 3D space corresponding to the point cloud is X×Y×C, it may be assumed that the mask in the form of a grid corresponds to a BEV plane of the 3D space corresponding to the size of X×Y. It may be assumed that each grid cell of the mask has a height h and a width w. For a point pₖ=(xₖ, yₖ, zₖ)^{T} in the point cloud, the points corresponding to a grid cell g(i,j) of the mask may be determined as shown in Equation 1 below.

$${g}_{( i , j )} = \{ {p}_{k} \vert ⌊ {x}_{k} / w ⌋ = i , ⌊ {y}_{k} / h ⌋ = j \} \qquad Equation 1$$

In Equation 1, └·┘ denotes a rounding-down operation.

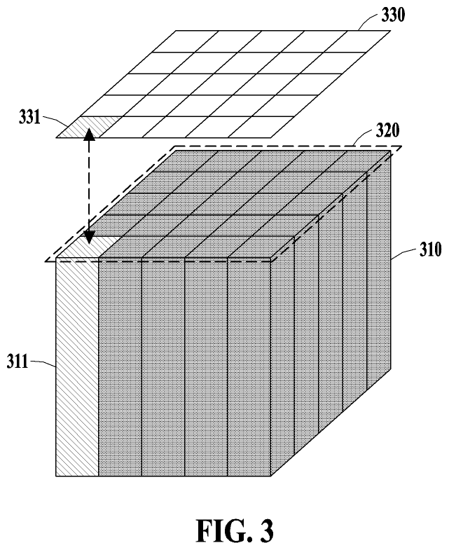

FIG. 3 illustrates example points corresponding to grid cells of a mask according to one or more embodiments.

Referring to FIG. 3, in a non-limiting example, it may be assumed that a mask 330 corresponding to a BEV plane 320 of a space 310 corresponding to the point cloud is in the form of a 5*5 grid. The space 310 corresponding to the point cloud may be divided into 25 voxels, with the BEV plane 320 divided into 5*5. Each grid cell of the mask 330 may correspond to each grid cell of the BEV plane 320 and may correspond to voxels corresponding to a grid cell of the BEV plane 320. For example, a first grid cell 331 of the mask 330 may correspond to a first grid cell of the BEV plane 320, and an (x, y) coordinate may correspond to a first voxel 311 corresponding to an area of the first grid cell 331.

A partial area of the point cloud may be masked based on the mask. A partial area of the point cloud or a partial point of the point cloud, which corresponds to the grid cell of the mask having a value (e.g., 0) indicating masking may be determined to be masked. The point determined to be masked may be removed from the point cloud or converted into a value (e.g., null or 0) indicating a blank space.

For example, in FIG. 3, when a value of the first grid cell 331 of the mask 330 is a value (e.g., 0) indicating masking, the point(s) included in the first voxel 311 corresponding to the first grid cell 331 may be removed or converted into a value (e.g., null or 0) indicating a blank space.

Hereinafter, among the grid cells of the mask, a grid cell having a value indicating masking may be referred to as a masking grid cell, a grid cell having a value not indicating masking may be referred to as a residual grid cell, a point determined to be masked by the mask in the point cloud may be referred to as a masking point, and a point determined not to be masked may be referred to as a residual point.

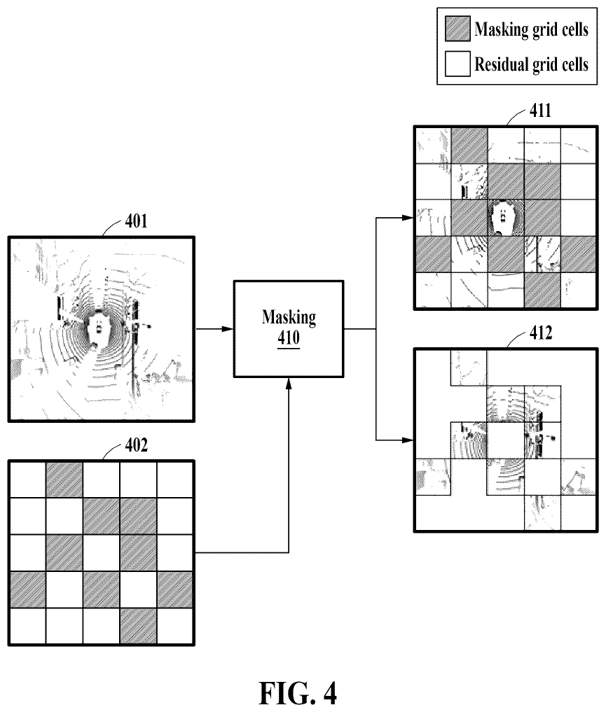

FIG. 4 illustrates an example masking of a point cloud according to one or more embodiments.

Referring to FIG. 4, in a non-limiting example, a point cloud 401 may be divided into residual points 411 and masking points 412 by masking 410 based on a mask 402. The residual points 411 may include point(s) included in an area (or voxel) corresponding to the residual grid cells in the point cloud 401. The masking points 412 may include point(s) included in an area (or voxel) corresponding to masking grid cells in the point cloud 401.

Referring again to FIG. 2, the multimodal data processing method 200 may further include, in an example, operation 220 of training a first auto-encoder.

In an example, in operation 220, the training of the first auto-encoder may include training the first auto-encoder to reconstruct coordinates and densities of masking points of the point cloud, which correspond to masking grid cells of the mask, from residual points of the point cloud, which correspond to residual grid cells of the mask.

The first auto-encoder may include an auto-encoder trained based on a point cloud input. The first auto-encoder may include a first encoder and a first decoder. The first encoder of the first auto-encoder may be trained to encode the residual points of the point cloud and extract features or embedding data. The first decoder of the first auto-encoder may be trained to reconstruct the masking points of the point cloud from the features extracted from the first encoder. The reconstruction of the masking points, which is performed by the first decoder, may include predicting the coordinates and the densities of the masking points.

In an example, in operation 220, the training of the first auto-encoder may include obtaining a point cloud feature by applying, to the first encoder of the first auto-encoder, the point cloud that is voxelized corresponding to the mask, obtaining a first BEV feature by converting the point cloud feature obtained from the first encoder into a BEV space, and training, from the first BEV feature, the first auto-encoder to reconstruct the coordinates and densities of the masking points in the first decoder of the first auto-encoder.

The voxelized point cloud corresponding to the mask may refer to the point cloud in which voxels corresponding to the masking grid cells are masked. As described above with reference to FIG. 3, the voxels of the point cloud may correspond to the grid cells of the mask, and the voxels of the point cloud corresponding to the masking grid cells may be masked.

The obtaining of the point cloud feature may include replacing masking voxels corresponding to the masking grid cells in the voxelized point cloud with point tokens and applying the point tokens to the first encoder. The point tokens may include learnable parameters. That is, the masking voxels may be replaced with the learnable parameters instead of information related to the point(s) included in the masking voxels. Relationship training between adjacent voxels may be possible by replacing the masking voxels with the point tokens.

The point cloud feature may be compressed or flattened along the z-axis and converted into the BEV space. That is, a 3D point cloud feature may be converted into a 2D first BEV feature.

The density to be reconstructed is the density of the masking voxel in the point cloud and may correspond to a ratio of the number of points included in the masking voxel to the volume of the masking voxel. For example, the density of each voxel may correspond to a value obtained by dividing the number of points included in each voxel by the volume of each voxel. Since the volume of voxels may correspond to a predetermined value, reconstructing the density may refer to predicting the number of masking points included in a certain masking voxel.

The first auto-encoder may be trained based on a loss function. For example, the first auto-encoder may be trained to minimize the value of a predefined loss function.

In an example, operation 220 may include training the first auto-encoder based on a first loss function defined such that a distance between a predicted point in the first auto-encoder and a ground-truth (GT) point is minimized. The GT point may include, among the masking points of the point cloud, a masking point that is closest to the predicted point. The first loss function is described in greater detail below.

In an example, operation 220 may include training the first auto-encoder based on a third loss function, the third loss function for training the first auto-encoder being defined such that a difference between a predicted density corresponding to a masking grid cell in the first auto-encoder and a GT density is minimized. The GT density may be obtained by dividing the number of masking points of the point cloud corresponding to the masking grid cells by the volume of the voxels of the point cloud corresponding to the masking grid cells. The third loss function is described in detail greater below.

In an example, operation 220 may include training the first auto-encoder based on a fourth loss function, the fourth loss function being defined such that a difference between a predicted surface normal corresponding to a masking grid cell in the first auto-encoder and a GT surface normal is minimized. The GT surface normal may be obtained by performing eigendecomposition on a covariance matrix of a relative coordinate distribution of points in voxels, in which the covariance matrix may be calculated based on a centroid of the voxels of the point cloud corresponding to the masking grid cells. The fourth loss function is described in greater detail below.

In an example, the multimodal data processing method 200 may also include operation 230 of training a second auto-encoder.

In an example, operation 230 may include training the second auto-encoder to reconstruct the colors, coordinates, and densities of the masking points from the image corresponding to the point cloud.

In an example, the second auto-encoder may include an auto-encoder trained based on an image input. The second auto-encoder may include a second encoder and a second decoder. The second encoder of the second auto-encoder may be trained to encode the image corresponding to the point cloud and extract features or embedding data. The second decoder of the second auto-encoder may be trained to reconstruct points of the point cloud from the features extracted from the second encoder. The reconstruction of the points of the point cloud, which may be performed by the second decoder, may include predicting the colors, coordinates, and densities of the points of the point cloud.

Color information of each point of the point cloud may be obtained based on the image. For example, based on a projection matrix corresponding to the point cloud and the image, a color value of a pixel in the image onto which a point of the point cloud is projected may be determined to be a color value of the point. The projection matrix corresponding to the point cloud and the image may be obtained based on a POV or depth information of the image. An operation of training the second auto-encoder to predict a color is described in greater detail below.

In an example, operation 230 may include obtaining an image feature by applying the image to the second encoder of the second auto-encoder, obtaining a second BEV feature obtained by converting the image feature obtained from the second encoder into a BEV space, based on the depth information of the image, and training, from the second BEV feature, the second auto-encoder to reconstruct the colors, coordinates, and densities of the masking points in the second decoder of the second auto-encoder.

For example, the image may include a plurality of images having different POVs. The depth information of the image may be estimated from the plurality of images having different POVs. The depth information of the image may be estimated by calculating the disparity of the plurality of images having different POVs. The image feature may be converted into the BEV space by using the depth information of the image.

The first auto-encoder may be trained based on a loss function. For example, the first auto-encoder may be trained to minimize the value of a predefined loss function.

In an example, operation 230 may include training the second auto-encoder based on a first loss function, the first loss function being defined such that a distance between a predicted point and a GT point is minimized. The GT point may include, among the points included in the point cloud, a point that is closest to the predicted point. The first loss function is described in detail below.

In an example, operation 230 may include obtaining a projection matrix corresponding to the point cloud and the image, determining a color value of a pixel in the image onto which a point of the point cloud is projected to be a color value of the point, based on the projection matrix, and training the second auto-encoder based on a second loss function, the second loss function being defined such that a difference between a color value of a predicted point and a color value of a GT point is minimized. The GT point may include, among the points included in the point cloud, a point that is closest to the predicted point. The second loss function is described in greater detail below.

In an example, operation 230 may include training the second auto-encoder based on a third loss function, the third loss function for training the second auto-encoder being defined such that a difference between a predicted density corresponding to a grid cell of the point cloud in the second auto-encoder and a GT density is minimized. As described above, the GT density may be obtained by dividing the number of masking points of the point cloud corresponding to the masking grid cells by the volume of the voxels of the point cloud corresponding to the masking grid cells. The third loss function is described in greater detail below.

In an example, the multimodal data processing method 200 may include an operation of obtaining embedding data of an input point cloud and an input image based on the first encoder of the trained first auto-encoder and the second encoder of the trained second auto-encoder. For example, the embedding data obtained by applying the input point cloud to the first encoder and the embedding data obtained by applying the input image to the second encoder may be fused. The fusion of multimodal embedding data including the embedding data of the point cloud and the embedding data of the image may include various methods of concatenating the pieces of embedding data or performing an operation (e.g., sum, average, weighted sum, etc.) on the pieces of embedding data. The pieces of embedding data of the input point cloud and the input image may be used for various data outputs. For example, output data corresponding to a corresponding task may be obtained by being applied to a head corresponding to a certain task. For example, the pieces of embedding data of the input point cloud and the input image may be applied to a head for object detection, so an object detection result may be obtained. For example, the pieces of embedding data of the input point cloud and the input image may be applied to a head for map segmentation, so a map segmentation result may be obtained.

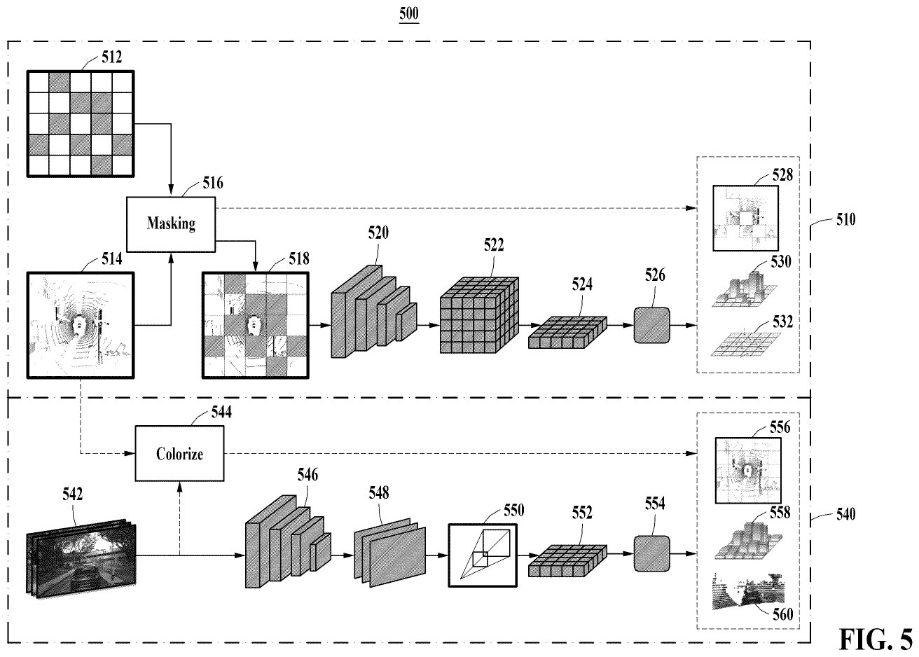

FIG. 5 illustrates an example training pipeline of a bird's eye view masked multimodal auto-encoder (BEV-MMAE) according to one or more embodiments.

Referring to FIG. 5, in a non-limiting example, BEV-MMAE 500 may correspond to a self-supervised learning framework capable of processing a multimodal input obtained by fusing a point cloud 514 and an image(s) 542 obtained from LiDAR. The BEV-MMAE 500 may correspond to the system 100 of FIG. 1. The BEV-MMAE 500 may be a system that performs a multimodal data processing method (e.g., the multimodal data processing method of FIG. 2).

In an example, training in a LiDAR pipeline 510 may include a task of reconstructing a point cloud that is masked. Specifically, a portion of the point cloud 514 that is input may be masked 516 using a BEV-guided point cloud masking strategy 512. A first auto-encoder including a first encoder 520 and a first decoder 522 may be trained to reconstruct points removed by masking from the point cloud 514, from a residual point cloud 518 that is not removed by masking.

Training in a camera pipeline 540 may include the task of reconstructing the point cloud 514 from the image(s) 542 that may be input.

The first decoder 524 and a second decoder 554 may be trained to predict coordinates 528 and 558 and densities 530 and 558 of a point(s) in an area of the point cloud 514 corresponding to each grid cell. Additionally, the first decoder 526 may be trained to predict a surface normal 532, and the second decoder 554 may be trained to predict a color 560 of a point in the point cloud 514.

It may be assumed that the resolution of a point cloud feature 522 obtained through encoding with respect to the residual point cloud 518 in the first encoder 520 is X×Y×C. It may be assumed that a BEV plane in the form of a grid corresponding to the point cloud 514 is defined as a size of X×Y and each grid cell corresponding to the BEV plane has a height h and a width w. For each point pₖ=(xₖ, yₖ, zₖ) T in the point cloud 514, points positioned inside a grid cell g_{(i,j)} may be determined as shown in Equation 1 described above. The grid cell g_{(i,j)} may correspond to a voxel in which an (x, y) coordinate is included in the grid cell g_{(i,j)} in a 3D space corresponding to the point cloud 514. That is, the grid cell g_{(i,j)} may be interpreted as a 3D voxel.

In the point cloud reconstruction task, the grid cell g_{(i,j)} may be a reconstruction target of each grid cell. The first decoder 526 of the BEV-MMAE 500 may predict the reconstruction result based on a first BEV feature.

In the LiDAR pipeline 510, a portion of the grid cells, that is, a non-empty grid cell (i.e., g_{(i,j)}≠Ø), may be randomly selected. A set of indexes of all grid cells may be represented as A={(i,j)|0≤i<X,0≤j<Y}, and a set of indexes of masked grid cells may be represented as M={(i,j)|g_{(i,j)} is masked}. The residual point cloud 518 ∪_{i∈A-M}gᵢ that is not masked may be provided as an input of the first encoder 520 together with a shared learnable point token that replaces a masked point cloud Crew ∪_{i∈M}gᵢ. The point token may be used to transmit information between voxels without exposing information about a masked point while maintaining the size of a receptive field.

The first encoder 520 may process a voxelized point cloud by performing a 3D sparse convolution operation. The point cloud feature 522 obtained from the first encoder 520 is a 3D feature and may be compressed along the z-axis through flattening and converted into a BEV space. A feature obtained by converting the point cloud feature 522 into the BEV space may be referred to as a first BEV feature 524. The first decoder 526 may reconstruct, using the first BEV feature 524, a masked point cloud by predicting a masked area, that is, the coordinate 528 and the density 530 of a point and the surface normal 532 of a grid cell for ∀(i,j) EM.

In the camera pipeline 540, the image(s) 542 of multi-view may be processed through a second encoder 546 corresponding to a convolutional neural network (CNN) or a transformer backbone. An image feature 548 obtained from the second encoder 546 may be converted into a BEV space 550 by using depth information estimated corresponding to the image(s) 542 of multi-view. A feature obtained by converting the image feature 548 into the BEV space 550 may be referred to as a second BEV feature 552. The second decoder 554 may reconstruct the point cloud 514 and color information by predicting the coordinate 556, the density 558, and the color 560 of a point for all grid cells (i,j) ∈A, based on the second BEV feature 552. The first decoder 526 and the second decoder 554 may be used only in the training stage, and the first decoder 526 and the second decoder 554 may be removed when a trained weight is used in the downstream task. The second decoder 526 may predict the color 560 of the points for all grid cells (i,j) ∈A, based on a colorized 544 result of the point cloud 514. The colorized 544 result of the point cloud 514 may be obtained through an operation of determining the color value of a point of the point cloud 514 based on the color value of a pixel in the image(s) 542 onto which the point is projected.

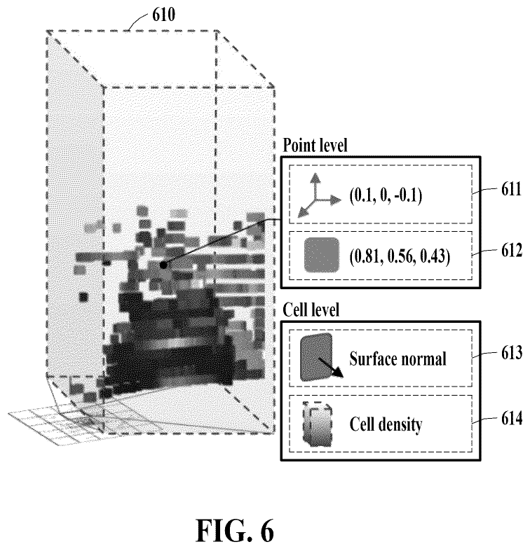

FIG. 6 illustrates an example reconstruction objective of a BEV-MMAE according to one or more embodiments.

Referring to FIG. 6, in a non-limiting example, an auto-encoder of the BEV-MMAE may be trained to reconstruct a point cloud based on four loss functions having the properties of the point cloud corresponding to each grid cell as objectives. The auto-encoder of the BEV-MMAE may include a first auto-encoder (e.g., first auto-encoder 110 of FIG. 1) and a second auto-encoder (e.g., second auto-encoder 120 of FIG. 1) described above. The auto-encoder of the BEV-MMAE may be trained to predict the properties of the point cloud for each voxel 610 of the point cloud corresponding to a grid cell. The properties of the point cloud may include a coordinate 611 of a point and a color 612 of a point, which are the properties at the point level. The properties of the point cloud may include a density 614 and a surface normal 613, which are properties at the cell level.

A set-to-set prediction approach may be used for each grid cell to reconstruct a local structure of the point cloud. Specifically, a 1×1 convolution layer may be applied to each grid cell to predict a set of points, which is represented as P_{(i,j)}. For example, the size of P_{(i,j)} may be a fixed number, for example, |P_{(i,j)}|=20. The loss objective may be performing alignment of a coordinate of an original point g_{(i,j)} and a coordinate of a predicted point in each grid cell in which the quantities of included points may be different.

In an example, a first loss function may be defined using a chamfer distance. Through the first loss function, a first decoder and a second decoder may be trained to match a predicted point p∈P_{(i,j)} with the closest GT point q∈g_{(i,j)} and minimize the Euclidean distance between the predicted point p∈P_{(i,j)} and the GT point q∈g_{(i,j)}. The GT point q∈g_{(i,j)} that is closest to the predicted point p∈P_{(i,j)} may be determined, among actual points included in the original point cloud, to be a point that has the closest Euclidean distance to the predicted point p∈P_{(i,j)}. For example, the first loss function may be defined as shown in Equation 2 below.

$${ℒ}_{coor} ( i , j ) = \frac{1}{\vert {P}_{( i , j )} \vert} {\sum }_{p ∈ {P}_{( i , j )}} {min}_{q ∈ {q}_{( i , j )}} {‖ p - q ‖}_{2}^{2} + \frac{1}{\vert {g}_{( i , j )} \vert} {\sum }_{q ∈ {g}_{( i , j )}} {min}_{p ∈ {P}_{( i , j )}} {‖ q - p ‖}_{2}^{2} . \qquad Equation 2$$

By employing training that is based on the first loss function the predicted point may be induced to follow a distribution similar to the actual point and may allow effective training even when there is a difference in the number of predicted points and the actual points.

Since coordinate values of each actual point may vary greatly for each grid, directly predicting the absolute coordinate may lead to instability in the training process. To alleviate this, the first auto-encoder and the second auto-encoder may be trained to predict a normalized canonical coordinate based on each grid cell. More specifically, a canonical coordinate of each point may be calculated as an offset based on the center of each grid cell, which may be normalized to the size of the grid.

In an example, in a camera pipeline (e.g., camera pipeline 540 of FIG. 5), a second loss function for a color estimation may be used to train semantic information. When a projection matrix T_{LIDAR-img} toward an image is given in an input image and the point cloud, an image coordinate (uk, vk) of each point may be obtained as shown in Equation 3 below.

$$( \begin{matrix}{u}_{k} \\ {υ}_{k}\end{matrix} ) = {T}_{LiDAR \to img} \cdot ( \begin{matrix}{x}_{k} \\ {y}_{k} \\ {z}_{k} \\ 1\end{matrix} ) \qquad Equation 3$$

Each point in the point cloud may inherit a color Cₚₖ of a pixel corresponding to a coordinate that is projected onto an image. That is, the color information of each point in the point cloud may be determined to be the color Cₚₖ of the pixel of the coordinate in which each point is projected onto the image.

For example, the second decoder may predict colors for 20 predicted points by using a 1×1 convolution layer. The second loss function, Smooth-L1 loss, may be used to train the second decoder. Through the second loss function, the second decoder may be trained to minimize a difference between a predicted color of each predicted point and a color of a GT point that is closest to the point. In an example, the second loss function may be defined as shown in Equation 4 below.

$${ℒ}_{color} ( i , j ) = \frac{1}{\vert {P}_{( i , j )} \vert} {\sum }_{p ∈ {P}_{( i , j )}} SmoothL 1 ( {c}_{p} , {c}_{q} ) + \frac{1}{\vert {g}_{( i , j )} \vert} {\sum }_{q ∈ {g}_{( i , j )}} SmoothL 1 ( {c}_{q} , {c}_{p} ) . \qquad Equation 4$$

Semantic alignment between the point cloud and image data may be performed through the second loss function.

As described above, the coordinates of 20 points may be predicted to reconstruct a spatial distribution of the point cloud in each grid cell. For example, in an autonomous driving scenario, since the densities of the point cloud varies greatly depending on the space due to the distance and occlusion, density information may be required for accurate point cloud reconstruction.

For each grid cell, a density p_{(i,j)} may be calculated by calculating the number of points in a corresponding grid cell and dividing the number of points by the occupied volume in the 3D space. For example, each of the first decoder and the second decoder may perform density prediction \hat{p}_{(i,j)} using a 1×1 convolution layer and may be trained using a third loss function, Smooth-L1 loss. In an example, the third loss function may be defined as shown in Equation 5 below.

$${ℒ}_{den} ( i , j ) = SmoothL 1 ( {\hat{ρ}}_{( i , j )} , {ρ}_{( i , j )} ) \qquad Equation 5$$

In an example, a fourth loss function for a surface normal estimation may be designed to predict the direction of the surface in each grid cell. However, when a grid cell does not include enough points, a GT surface normal may be calculated incorrectly. Accordingly, the fourth loss function may only be calculated for a grid cell that includes more than a predetermined number of points (e.g., 5). The fourth loss function may include the first auto-encoder to train a geometric cue associated with the boundary and surface direction of an object.

For each grid cell g_{(i,j)}, a point centroid p_{(i,j)}=mean (g_{(i,j)}) indicating a center position of a point in a corresponding grid cell may be calculated first. Next, a relative coordinate with respect to the centroid may be calculated by subtracting the centroid from the coordinate of each point in the grid cell. Eigendecomposition may be performed on a covariance matrix of a point distribution. As a result of eigendecomposition, a set of eigenvalues and eigenvectors may be generated. An eigenvector corresponding to the smallest eigenvalue may indicate the minimum dispersion direction of the point cloud, and the eigenvector corresponding to the smallest eigenvalue may be determined to be a surface normal n_{(i,j)}.

For example, the first decoder may include a 1×1 convolution layer and may predict a surface normal \hat{n}_{(i,j)} of each grid cell by using the 1×1 convolution layer. The fourth loss function may be defined to minimize a cosine distance between a predicted surface normal and a GT surface normal. In an example, the fourth loss function may be defined as shown in Equation 6 below.

$${ℒ}_{norm} ( i , j ) = 1 - cos ( {\hat{n}}_{( i , j )} , {n}_{( i , j )} ) . \qquad Equation 6$$

The fourth loss function may induce the predicted surface normal \hat{n}_{(i,j)} to align with the GT surface normal n_{(i,j)}, thereby facilitating accurate surface direction prediction.

The total loss functions

$${L}_{total}^{LiDAR} and {L}_{total}^{RGB}$$

for training the first auto-encoder and the second auto-encoder may be determined to be a weighted sum of individual loss function items.

In an example, the total loss function

$${L}_{total}^{LiDAR}$$

for training the first auto-encoder may be defined as shown in Equation 7 below.

$${ℒ}_{total}^{LiDAR} = \frac{1}{\vert M \vert} {\sum }_{( i , j ) ∈ M} {λ}_{den} {ℒ}_{den} ( i , j ) + {λ}_{coor} {ℒ}_{coor} ( i , j ) + {λ}_{norm} {ℒ}_{norm} ( i , j ) , \qquad Equation 7$$

In an example, the total loss function

$${L}_{total}^{RGB}$$

for training the second auto-encoder may be defined as shown in Equation 8 below.

$${ℒ}_{total}^{RGB} = \frac{1}{\vert A \vert} {\sum }_{( i , j ) ∈ A} {λ}_{den} {ℒ}_{den} ( i , j ) + {λ}_{coor} {ℒ}_{coor} ( i , j ) + {λ}_{color} {ℒ}_{color} ( i , j ) , \qquad Equation 8$$

In Equations 7 and 8, λ_{den}, λ_{coor}, λₙₒᵣₘ and λ_{color} denote hyperparameters that control the degree to which each loss function item contributes to the total loss function.

For example,

$${ℒ}_{total}^{LiDAR}$$

may be calculated only for a masked grid cell and the

$${L}_{total}^{RGB}$$

may be calculated for all grid cells. The total loss function may ensure that a model trains geometric and semantic features effectively, thereby improving 3D recognition performance using multimodal data.

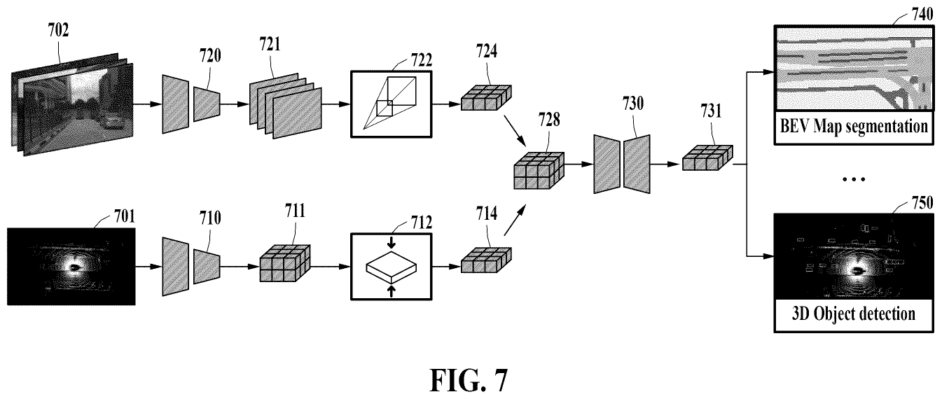

FIG. 7 illustrates an example process of obtaining an object detection result and a map segmentation result according to one or more embodiments.

Referring to FIG. 7, in a non-limiting example, a trained first encoder 710 may output a point cloud feature 711 corresponding to a point cloud 701, which may be sensed by LiDAR. The point cloud feature 711 may be compressed into a BEV space 712 and converted into a first BEV feature 714.

In an example, a trained second encoder 720 may output an image feature 721 corresponding to an image(s) 702 corresponding to the point cloud 701. The image feature 721 may be converted into a BEV space 722 and converted into a second BEV feature 724.

The first BEV feature 714 and the second BEV feature 724 may be fused 728 and input to a task-specific head for a certain task. The feature obtained by the fusing 728 of the first BEV feature 714 and the second BEV feature 724 may correspond to the embedding data of the input point cloud and the input image as described above. For example, the first BEV feature 714 and the second BEV feature 724 may be connected to each other, and the connected feature may be converted into embedding data 731 for a certain task through an encoder 730.

For example, a certain task may include at least one of an object detection task 740 and a map segmentation task 750.

The embedding data 731 for a certain task obtained by fusing the first BEV feature 714 and the second BEV feature 724 may be input to a head for a certain task. Output data corresponding to a certain task may be obtained from the head for a certain task to which the embedding data 731 is applied. For example, the output data may include an object detection result (e.g., object detection task 740) corresponding to the point cloud. For example, the output data may include a map segmentation result (e.g., map segmentation task 750) corresponding to the point cloud.

The first encoder and the second encoder trained through the methods described above with reference to FIGS. 1 to 6 may be included in a model that uses data obtained through LiDAR and a camera, such as 3D object recognition for autonomous driving.

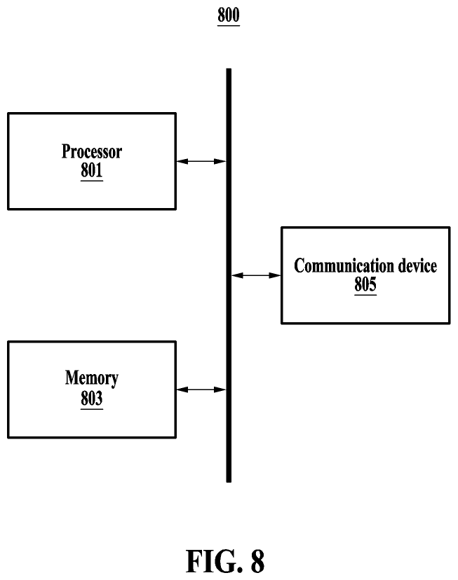

FIG. 8 illustrates an electronic device according to one or more embodiments.

Referring to FIG. 8, in a non-limiting example, an electronic device 800 may include a processor 801, a memory 803, and a communication device 805. The electronic device 800 may include an apparatus for performing multimodal data processing (e.g., the multimodal data processing method 200) described above with reference to FIGS. 1 to 7.

The processor 801 may perform at least one operation described above with reference to FIGS. 1 to 7. For example, the processor 801 may perform at least one of masking a point cloud based on a mask in the form of a grid, training a first auto-encoder to reconstruct coordinates and densities of masking points of the point cloud, which correspond to masking grid cells of the mask, from residual points of the point cloud, which correspond to residual grid cells of the mask, training a second auto-encoder to reconstruct colors, the coordinates, and the densities of the masking points from an image corresponding to the point cloud, and obtaining embedding data of an input point cloud and an input image based on a first encoder of the trained first auto-encoder and a second encoder of the trained second auto-encoder.

The memory 803 may be a volatile memory or a non-volatile memory and may store data related to a multimodal data processing method (e.g., the multimodal data processing method 200) described above with reference to FIGS. 1 to 7. For example, the memory 803 may store data generated during a process of performing the multimodal data processing method or data necessary for performing the multimodal data processing method. For example, the memory 803 may store a weight(s) of a layer(s) included in the trained first encoder and a weight(s) of a layer(s) included in the trained second encoder.

The communication device 805 may provide a function for the electronic device 800 to communicate with another electronic device or another server through a network. In other words, the electronic device 800 may be connected to an external device (e.g., a terminal of a user, a server, or a network) through the communication device 805 and may exchange data with the external device.

In an example, the memory 803 may not be a component of the electronic device 800 but may be included in an external device accessible by the electronic device 800. In this case, the electronic device 800 may receive data stored in the memory 803 included in the external device and transmit data to be stored in the memory 803 through the communication device 805.

The processor 801 may be configured to execute programs or applications to configure the processor 801 to control the electronic apparatus 800 to perform one or more or all operations and/or methods involving multimodal data processing, and may include any one or a combination of two or more of, for example, a central processing unit (CPU), a graphic processing unit (GPU), a neural processing unit (NPU) and tensor processing units (TPUs), but is not limited to the above-described examples.

The memory 803 may include computer-readable instructions. The processor 802 may be configured to execute computer-readable instructions, such as those stored in the memory 803, and through execution of the computer-readable instructions, the processor 802 is configured to perform one or more, or any combination, of the operations and/or methods described herein. The instruction(s) stored in the memory 803, when executed by the processor 801, may cause the electronic device 800 to perform masking a point cloud based on a mask in the form of a grid, training a first auto-encoder to reconstruct coordinates and densities of masking points of the point cloud, which correspond to masking grid cells of the mask, from residual points of the point cloud, which correspond to residual grid cells of the mask, training a second auto-encoder to reconstruct colors, the coordinates, and the densities of the masking points from an image corresponding to the point cloud, and obtaining embedding data of an input point cloud and an input image based on a first encoder of the trained first auto-encoder and a second encoder of the trained second auto-encoder.

The electronic device 800 may further include other components not shown in the drawings. For example, the electronic device 800 may further include an input/output interface including an input device and an output device as the means for interfacing with the communication device 805. In addition, for example, the electronic device 800 may further include other components such as a transceiver, various sensors, and a database.

The neural networks, electronic devices, communication devices, processors, memories, encoders, point cloud 101, first auto-encoder 110, second auto-encoder 120, electronic device 800, communication device 805, processor 801, and memory 803 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
masking a point cloud according to a mask, the mask being formed as a grid;
training a first auto-encoder to reconstruct coordinates and densities of masking points of the point cloud, the masking points respectively corresponding to masking grid cells of the mask, from residual points of the point cloud, the residual points respectively corresponding to residual grid cells of the mask; and
training a second auto-encoder to reconstruct colors, the coordinates, and the densities of the masking points from an image corresponding to the point cloud.

2. The method of claim 1, wherein a first encoder of the trained first auto-encoder and a second encoder of the trained second auto-encoder are respectively configured to output embedding data of an input point cloud and an input image.

3. The method of claim 1, wherein the training of the first auto-encoder comprises:
obtaining a point cloud feature by applying, to a first encoder of the first auto-encoder, the point cloud being voxelized responsive to the masking;
obtaining a first bird's eye view (BEV) feature by converting the point cloud feature obtained from the first encoder into a BEV space; and
training, from the first BEV feature, the first auto-encoder to reconstruct the coordinates and the densities of the masking points in a first decoder of the first auto-encoder.

4. The method of claim 3, wherein the obtaining of the point cloud feature comprises:
replacing masking voxels corresponding to the masking grid cells in the voxelized point cloud with point tokens; and
applying the point tokens to the first encoder.

5. The method of claim 1, wherein the training of the second auto-encoder comprises:
obtaining an image feature by applying the image to a second encoder of the second auto-encoder;
obtaining a second bird's eye view (BEV) feature obtained by converting the image feature obtained from the second encoder into a BEV space, based on depth information of the image; and
training, from the second BEV feature, the second auto-encoder to reconstruct the colors, the coordinates, and the densities of the masking points in a second decoder of the second auto-encoder.

6. The method of claim 1, wherein the training of the first auto-encoder comprises:
training the first auto-encoder based on a first loss function of the first auto-encoder, the first loss function of the first auto-encoder being defined to minimize a first distance between a predicted point in the first auto-encoder and a ground-truth (GT) point, and
wherein the GT point comprises, among the masking points of the point cloud, a masking point closest to the predicted point.

7. The method of claim 1, wherein the training of the first auto-encoder comprises:
training the first auto-encoder based on a third loss function, the third loss function being defined to minimize a first difference between a predicted density corresponding to a masking grid cell in the first auto-encoder and a ground-truth (GT) density is minimized, and
wherein the GT density is obtained by dividing a number of the masking points of the point cloud corresponding to the masking grid cells by a volume of voxels of the point cloud corresponding to the masking grid cells.

8. The method of claim 1, wherein the training of the first auto-encoder comprises:
training the first auto-encoder based on a fourth loss function, the fourth loss function being defined to minimize a second difference between a predicted surface normal corresponding to a masking grid cell in the first auto-encoder and a ground-truth (GT) surface normal, and
wherein the GT surface normal is obtained by performing eigendecomposition on a covariance matrix of a relative coordinate distribution of points in voxels, wherein the covariance matrix is calculated based on a centroid of the voxels of the point cloud corresponding to the masking grid cells.

9. The method of claim 1, wherein the training of the second auto-encoder comprises:
training the second auto-encoder based on a first loss function of the second auto-encoder, the first loss function of the second auto-encoder being defined to minimize a second distance between a predicted point and a ground-truth (GT) point, and
wherein the GT point comprises, among points comprised in the point cloud, a point that is closest to the predicted point.

10. The method of claim 1, wherein the training of the second auto-encoder comprises:
obtaining a projection matrix corresponding to the point cloud and the image;
determining a color value of a pixel in the image onto which a point of the point cloud is projected to be a color value of the point, based on the projection matrix; and
training the second auto-encoder based on a second loss function of the second auto-encoder, the second loss function of the second auto-encoder being defined to minimize a third difference between a color value of a predicted point and a color value of a ground-truth (GT) point is minimized, and
wherein the GT point comprises, among points comprised in the point cloud, a point that is closest to the predicted point.

11. The method of claim 1, wherein the training of the second auto-encoder comprises:
training the second auto-encoder based on a third loss function of the second auto-encoder, the third loss function of the second auto-encoder being defined to minimize a fourth difference between a predicted density corresponding to a grid cell of the point cloud in the second auto-encoder and a ground-truth (GT) density, and
wherein the GT density is obtained by dividing a number of the masking points of the point cloud corresponding to the masking grid cells by a volume of voxels of the point cloud corresponding to the masking grid cells.

12. The method of claim 1, wherein the point cloud comprises data sensed by light detection and ranging (LiDAR), and
wherein the image comprises data captured by a camera that senses at least a portion of a scanning range of the LiDAR.

13. The method of claim 1, further comprising:
obtaining embedding data of an input point cloud and an input image based on a first encoder of the trained first auto-encoder and a second encoder of the trained second auto-encoder; and
obtaining an object detection result based on the embedding data.

14. The method of claim 1, further comprising:
obtaining embedding data of an input point cloud and an input image based on a first encoder of the trained first auto-encoder and a second encoder of the trained second auto-encoder; and
obtaining a map segmentation result based on the embedding data.

15. A non-transitory computer-readable storage medium storing instructions that, when executed by a processor, cause the processor to:
mask a point cloud according to a mask, the mask being formed as a grid;
train a first auto-encoder to reconstruct coordinates and densities of masking points of the point cloud, the masking points respectively corresponding to masking grid cells of the mask, from residual points of the point cloud, the residual points respectively corresponding to residual grid cells of the mask; and
train a second auto-encoder to reconstruct colors, the coordinates, and the densities of the masking points from an image corresponding to the point cloud.

16. An electronic device comprising:
at least one processor; and
a memory configured to store instructions,
wherein the instructions, when executed by the at least one processor, cause the electronic device to perform:
masking a point cloud according to a mask, the mask being formed as a grid;
training a first auto-encoder to reconstruct coordinates and densities of masking points of the point cloud, the masking points respectively corresponding to masking grid cells of the mask, from residual points of the point cloud, the residual points respectively corresponding to residual grid cells of the mask; and
training a second auto-encoder to reconstruct colors, the coordinates, and the densities of the masking points from an image corresponding to the point cloud.

17. The electronic device of claim 16, wherein the training of the first auto-encoder comprises:
obtaining a point cloud feature by applying, to a first encoder of the first auto-encoder, the point cloud being voxelized responsive to the masking;
obtaining a first bird's eye view (BEV) feature by converting the point cloud feature obtained from the first encoder into a BEV space; and
training, from the first BEV feature, the first auto-encoder to reconstruct the coordinates and the densities of the masking points in a first decoder of the first auto-encoder.

18. The electronic device of claim 17, wherein the obtaining of the point cloud feature comprises:
replacing masking voxels corresponding to the masking grid cells in the voxelized point cloud with point tokens; and
applying the point tokens to the first encoder.

19. The electronic device of claim 16, wherein the training of the second auto-encoder comprises:
obtaining an image feature by applying the image to a second encoder of the second auto-encoder;
obtaining a second bird's eye view (BEV) feature obtained by converting the image feature obtained from the second encoder into a BEV space, based on depth information of the image; and
training, from the second BEV feature, the second auto-encoder to reconstruct the colors, the coordinates, and the densities of the masking points in a second decoder of the second auto-encoder.

20. The electronic device of claim 16, wherein a first encoder of the trained first auto-encoder and a second encoder of the trained second auto-encoder are configured to output embedding data of an input point cloud and an input image.
